(19) United States
(12) Patent Application Publication
(10) Pub. No.: US 2012/0274619 A1
(43) Pub. Date: Nov. 1, 2012

(54) ELECTRONIC PAPER DISPLAY DEVICE AND DRIVING METHOD THEREOF

(75) Inventors: Young Woo LEE, Gyeonggi-do (KR); Hee Bum Lee, Gyeonggi-do (KR); Sang Moon Lee, Seoul (KR); Choong Hee Lee, Gyeonggi-do (KR)

(73) Assignee: SAMSUNG ELECTRO-MECHANICS CO., LTD., Suwon (KR)

(21) Appl. No.: 13/456,830

(22) Filed: Apr. 26, 2012

(30) Foreign Application Priority Data
Apr. 28, 2011 (KR) 10-2011-0040194

(51) Int. Cl. G09G 5/00

(52) U.S. Cl. 345/209

(57) ABSTRACT

Disclosed herein are an electronic paper display device and a driving method thereof. The electronic paper display device includes: rotating balls each having at least two display areas colored in different colors and including a portion charged with a positive charge and a portion charged with a negative charge; a driving controller generating a driving voltage for rotating the rotating balls; and an upper electrode and a lower electrode provided above and below the rotating balls, respectively, and receiving a driving voltage from the driving controller, wherein the driving controller may apply a first driving voltage for rotating the rotating balls between the upper electrode and the lower electrode for time duration T1 and apply a second driving voltage, which has a polarity opposite to that of the first driving voltage, between the upper electrode and the lower electrode for time duration T2.

### CROSS REFERENCE(S) TO RELATED APPLICATIONS

This application claims the benefit under 35 U.S.C. Section 119 of Korean Patent Application Serial No. 10-2011-0040194, entitled “Electronic Paper Display Device and Driving Method Thereof” filed on Apr. 28, 2011, which is hereby incorporated by reference in its entirety into this application.

### BACKGROUND OF THE INVENTION

1. Technical Field

The present invention relates to an electronic paper display device and a driving method thereof.

2. Description of the Related Art

Electronic paper refers to a display device for displaying characters, images, or the like, on a thin substrate made of resin, or the like. Since the electronic paper display device can become thinner and has flexibility, it has been applied to various types of electronic books or electronic labels as a display device which may be able to substitute traditional print media such as books, newspapers, magazines, and the like, in the future.

Electronic paper may be classified into electrophoretic type electronic paper and rotating ball type electronic paper.

Electrophoretic type electronic paper is paper in which tens to millions of fine electrophoretic particles assuming electric charges are formed between electrodes and voltage is applied to the electrodes to express various characters and images.

Meanwhile, rotating ball type electrode paper is paper in which rotating balls (or twisting balls), each having a positive electric charge and a negative electric charge and having a surface colored in two or more colors, rather than electrophoretic particles, are formed between electrodes, and the rotating balls are rotated by a driving voltage applied to the electrodes to express two or more colors.

Unlike electrophoretic type electronic paper, electronic paper employing the rotating ball scheme expresses black, white, or the like, by rotating hemispherical surface of rotating balls, and in this case, since it is difficult to finely or minutely adjust the angle of rotating balls, rotating ball type electronic paper can express just white or black in most cases.

In rotating ball type electronic paper, several rotating balls expressed in white and black may be grouped to combine white and black to express gradual gray levels, step by step. In this case, however, a plurality of rotating balls are required to express gray as one unit, which increases the area of a minimum unit expressed in gray but lowers resolution of an image.

Namely, in the related art, the rotating ball type electronic paper has a limitation in expressing gradation while preventing a degradation of resolution.

### SUMMARY OF THE INVENTION

An object of the present invention is to provide an electronic paper display device capable of expressing various gradations by controlling a driving voltage applied to electrodes, and a driving method thereof.

According to an exemplary embodiment of the present invention, there is provided an electronic paper display device including: rotating balls each having at least two display areas colored in different colors and including a portion charged with a positive charge and a portion charged with a negative charge; a driving controller generating a driving voltage for rotating the rotating balls; and an upper electrode and a lower electrode provided above and below the rotating balls, respectively, and receiving a driving voltage from the driving controller, wherein the driving controller may apply a first driving voltage for rotating the rotating balls between the upper electrode and the lower electrode for time duration T1 and apply a second driving voltage, which has a polarity opposite to that of the first driving voltage, between the upper electrode and the lower electrode for time duration T2.

The first driving voltage and the second driving voltage may have the same absolute value, and the time durations T1 and T2 may be different.

The first driving voltage and the second driving voltage may have different absolute values, and the time durations T1 and T2 may be equal.

The first driving voltage and the second driving voltage may have different absolute values, and the time durations T1 and T2 may be different.

The driving controller may repeatedly perform a process of applying the first driving voltage between the upper electrode and the lower electrode for the time duration T1 and applying the second driving voltage between the upper electrode and the lower electrode for the time duration T2 at least two times sequentially.

According to another exemplary embodiment of the present invention, there is provided a method for driving an electronic paper display device in which rotating balls, each having at least two display areas colored in different colors and including a portion charged with a positive charge and a portion charged with a negative charge, are positioned between an upper electrode and a lower electrode, including: applying a first driving voltage for rotating the rotating balls between the upper electrode and the lower electrode for time duration T1; and applying a second driving voltage, which has a polarity opposite to that of the first driving voltage, between the upper electrode and the lower electrode for time duration T2.

The first driving voltage and the second driving voltage may have the same absolute value, and the time durations T1 and T2 may be different.

The first driving voltage and the second driving voltage may have different absolute values, and the time durations T1 and T2 may be equal.

The first driving voltage and the second driving voltage may have different absolute values, and the time durations T1 and T2 may be different.

The applying of the first driving voltage between the upper electrode and the lower electrode for the time duration T1; and the applying of the second driving voltage between the upper electrode and the lower electrode for the time duration T2 may be repeatedly performed at least two times sequentially.

### BRIEF DESCRIPTION OF THE DRAWINGS

FIG. 1 is a schematic view of an electronic paper display device according to an exemplary embodiment of the present invention;

FIG. 2 is a schematic view showing a rotated state of electronic balls in a state in which a driving voltage is applied to the electronic paper display device for a short period of time according to an exemplary embodiment of the present invention;

FIG. 3 is a schematic view showing a rotated state of electronic balls in a state in which a predetermined driving voltage is applied to the electronic paper display device for a required amount of time according to an exemplary embodiment of the present invention;

FIG. 4 is a view showing a temporal distribution of a driving voltage applied to the electronic paper display device according to an exemplary embodiment of the present invention;

FIG. 5 is a view showing a temporal distribution of a driving voltage applied to the electronic paper display device according to another exemplary embodiment of the present invention;

FIG. 6 is a view showing a temporal distribution of a driving voltage applied to the electronic paper display device according to still another exemplary embodiment of the present invention;

FIG. 7A is a view showing a rotated state of rotating balls according to an application of a driving voltage;

FIG. 7B is a view showing a rotated state of rotating balls according to an application of a driving voltage;

FIG. 7C is a view showing a rotated state of rotating balls according to an application of a driving voltage;

FIG. 8 is a view showing a rotated state of rotating balls according to an application of a driving voltage; and

FIG. 9 is a view showing a screen image output on the electronic paper display device according to an exemplary embodiment of the present invention.

### DESCRIPTION OF THE PREFERRED EMBODIMENTS

The foregoing and other objects, features, aspects and advantages of the present invention will become more apparent from the following detailed description of the present invention when taken in conjunction with the accompanying drawings. The present invention may, however, be embodied in many different forms and should not be construed as being limited to the embodiments set forth herein. Rather, these embodiments are provided so that this disclosure will be thorough and complete, and will fully convey the scope of the invention to those skilled in the art. Like numbers refer to like elements throughout the specification.

The terms used in the present application are merely used to describe particular embodiments, and are not intended to limit the present invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, steps, operations, elements, components, and/or groups thereof.

An electronic paper display device 100 according to an exemplary embodiment of the present invention will be described in detail with reference to the accompanying drawings.

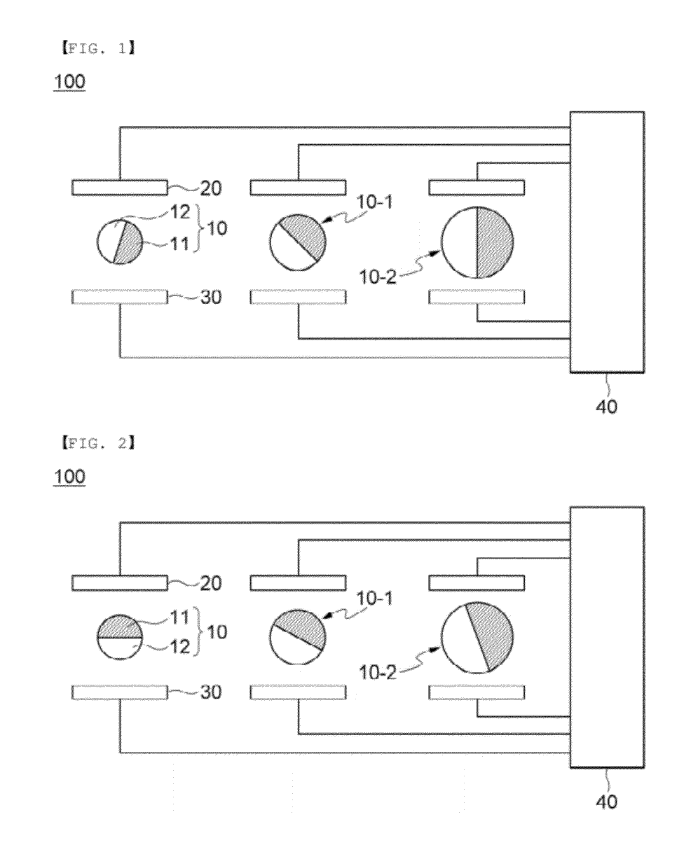

FIG. 1 is a schematic view of an electronic paper display device 100 according to an exemplary embodiment of the present invention.

Referring to FIG. 1, an electronic paper display device 100 according to an exemplary embodiment of the present invention may include a rotating ball 10, a driving controller 40, an upper electrode 20, and a lower electrode 30.

The rotating ball 10 may include at least two display areas colored in different colors, respectively. The display areas are expressed as a white area and a shaded area in FIG. 1. However, the present invention is not limited thereto and the rotating ball 10 may be divided into three or more areas colored in three or more colors. Hereinafter, the white area will be referred to as a white hemisphere 12 and the shaded area will be referred to as a black hemisphere 11.

The rotating ball 10 may include a portion charged with a positive charge and a portion charged with a negative charge. For example, the black hemisphere 11 may be charged with a negative charge and the white hemisphere 12 may be charged with a positive charge.

The upper electrode 20 and the lower electrode 30 may be positioned above and below the rotating ball 10 and forms an electric field upon receiving a driving voltage from the driving controller 40 to thus set a rotational state of the rotating ball 10.

Meanwhile, insulating oil that may have various compositions is filled between the upper electrode 20 and the lower electrode 30, and the rotating ball 10 may be provided within the insulating oil.

The driving controller 40 may serve to apply a driving voltage to each of the electrodes of the electronic paper display device 100 according to information such as characters, an image, or the like, to be displayed on the electronic paper display device 100.

Meanwhile, the driving controller 40 may receive information regarding gradation in addition to the characters or the image to be displayed on the electronic paper display device 100, and apply a driving voltage for expressing gradation between the upper electrode 20 and the lower electrode 30.

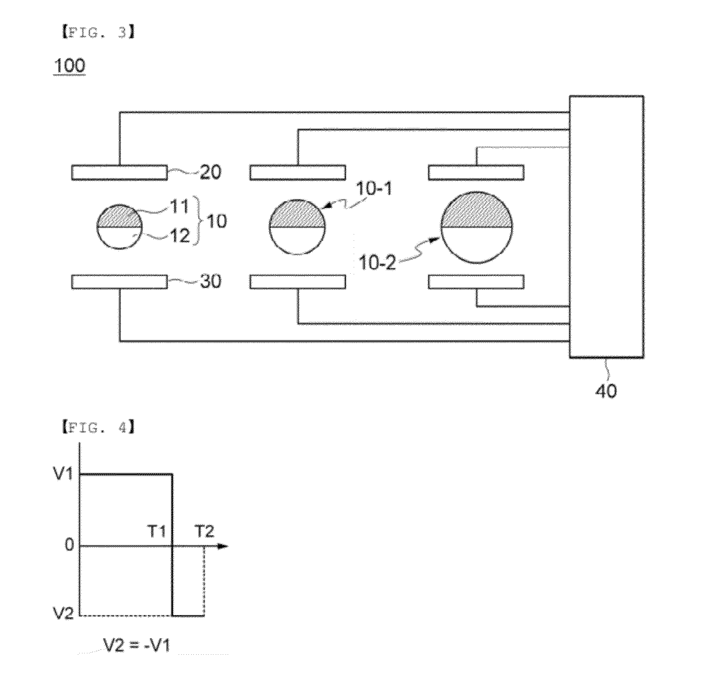

FIG. 2 is a schematic view showing a rotated state of electronic balls in a state in which a driving voltage is applied to the electronic paper display device 100 for a short period of time according to an exemplary embodiment of the present invention, and FIG. 3 is a schematic view showing a rotated state of electronic balls in a state in which a certain driving voltage is applied to the electronic paper display device 100 for a required amount of time according to an exemplary embodiment of the present invention. Here, it is assumed that the same driving voltage is applied to every display element.

The rotating balls 10 may be slightly different in their characteristics such as the diameter, the shape, a surface friction, weight, and the like. Such difference in the characteristics of the rotating balls 10 may affect the amount of rotation or speed of the rotation balls 10.

For example, as the diameter of the rotating ball is reduced, as the shape of the rotating ball is close to a spherical shape, as the surface friction of the rotating ball is reduced, and as the weight of the rotating ball is light, the amount of rotation or speed is increased when the same driving voltage is applied for the same period of time.

In FIGS. 2 and 3, in order to explain the driving characteristics of the electronic paper display device 100 due to the difference in the amount of rotation and speed according to the characteristics of the rotating balls 10, the rotating balls each having a different diameter are illustrated.

Referring to FIG. 2, it is noted that when the driving voltage is applied for a short period of time, the rotating ball 10 having the greatest amount of rotation and speed is sufficiently rotated such that the black hemisphere 11 faces in a vertically upward direction, while the rotating balls 10-1 and 10-2 having a small amount of rotation and speed have not rotated.

Meanwhile, referring to FIG. 3, it is noted that when a certain driving voltage is applied for a sufficient period of time, all the rotating balls 10 can be sufficiently rotated such that the black hemisphere 11 faces in the vertically upward direction.

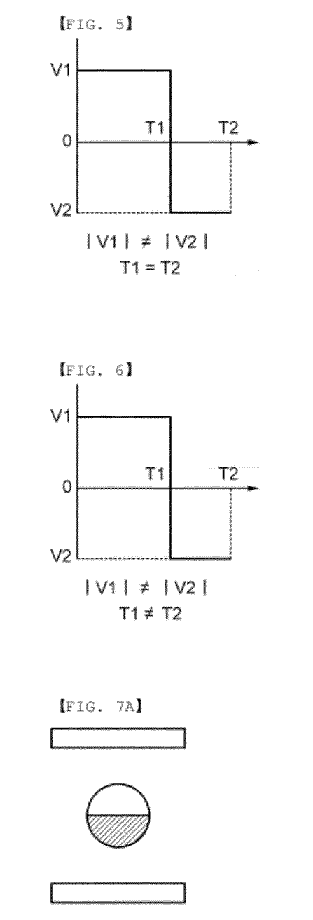

FIG. 4 is a view showing a temporal distribution of a driving voltage applied to the electronic paper display device 100 according to an exemplary embodiment of the present invention.

Referring to FIG. 4, the driving voltage may include a first driving voltage V1 and a second driving voltage V2. In this case, the second driving voltage V2 may have a polarity opposite to that of the first driving voltage V1.

The first driving voltage V1 and the second driving voltage V2 may have the same absolute value, and in this case, time duration T1 in which the first driving voltage V1 is applied and time duration T2 in which the second driving voltage V2 is applied may be different.

The first driving voltage V1 may have sufficient amplitude for rotating the rotating ball 10 up to a maximum 180°. The amplitude of the first driving voltage V1 may vary according to conditions such as the size of the rotating ball 10, the amount of charges, viscosity of the insulating oil, the interval between the upper and lower electrodes, and the like.

The first driving voltage V1 may serve to change the rotating ball 10 from a stationary state into a moving state.

When the rotating ball 10 is in a stationary state, greater force may be required to rotate the rotating ball 10 compared with the rotating ball 10 in a rotating state. Thus, in consideration of this, the first driving voltage V1 is applied to the rotating ball 10 in the stationary state to change the rotating ball 10 into a moving state such that the rotating ball 10 can be quickly rotated at a target angle.

Meanwhile, the second driving voltage V2 may have the same absolute value as that of the first driving voltage V1 but may have the opposite polarity to that of the first driving voltage V1. When the second driving voltage V2 is applied between the upper electrode 20 and the lower electrode 30, the rotating ball 10 is rotated such that the black hemisphere 11 faces in a vertically downward direction.

Also, the time durations T1 and T2 may be different. Here, based on the case in which the black hemisphere 11 of the rotating ball 10 faces in the vertically upward direction, the amount of tilting of the black hemisphere 11 can be controlled according to the size of the time duration T2 by applying the first driving voltage V1 and the second driving voltage V2 for the different time durations T1 and T2.

FIG. 5 is a view showing a temporal distribution of a driving voltage applied to the electronic paper display device 100 according to another exemplary embodiment of the present invention.

Referring to FIG. 5, a driving voltage may include a first driving voltage V1 and a second driving voltage V2. In this case, the second driving voltage V2 may have a polarity opposite to that of the first driving voltage V1 and may have a different absolute value from that of the first driving voltage V1. In this case, the time duration T1 in which the first driving voltage V1 is applied and the time duration T2 in which the second driving voltage V2 is applied may be equal.

The first driving voltage V1 may vary according to conditions such as the size of the rotating ball 10, the amount of charges, viscosity of the insulating oil, the interval between the upper and lower electrodes, and the like.

The first driving voltage V1 may serve to change the rotating ball 10 in a stationary state into a moving state.

When the rotating ball 10 is in a stationary state, greater force may be required to rotate the rotating ball 10 compared with the rotating ball 10 in a rotating state. Thus, in consideration of this, the first driving voltage V1 is applied to the rotating ball 10 in the stationary state to change the rotating ball 10 into a moving state such that the rotating ball 10 can be quickly rotated at a target angle.

Meanwhile, the second driving voltage V2 may have a different absolute value from that of the first driving voltage V1 and may have opposite polarity to that of the first driving voltage V1, and when the second driving voltage V2 is applied between the upper electrode 20 and the lower electrode 30, the rotating ball 10 is rotated such that the black hemisphere 11 faces in a vertically downward direction.

Also, the time durations T1 and T2 may be equal but the first driving voltage V1 and the second driving voltage V2 are different. Thus, based on the case in which the black hemisphere 11 of the rotating ball 10 faces in the vertically upward direction, the amount of tilting of the black hemisphere 11 can be controlled according to the difference in the absolute value between the first driving voltage V1 and the second driving voltage V2.

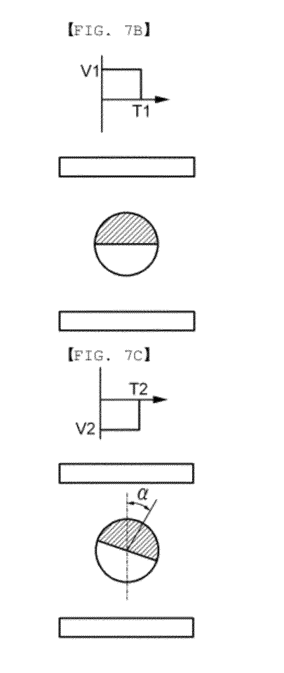

FIG. 6 is a view showing a temporal distribution of a driving voltage applied to the electronic paper display device 100 according to still another exemplary embodiment of the present invention.

Referring to FIG. 6, a driving voltage may include a first driving voltage V1 and a second driving voltage V2. In this case, the second driving voltage V2 may have a polarity opposite to that of the first driving voltage V1 and may have a different absolute value from that of the first driving voltage V1. In this case, the time duration T1 in which the first driving voltage V1 is applied and the time duration T2 in which the second driving voltage V2 is applied may be different.

The first driving voltage V1 may serve to change the rotating ball 10 from a stationary state into a moving state, and the second driving voltage V2 may serve to rotate the rotating ball 10 at a target angle.

Also, the time durations T1 and T2 may be set to be different.

Based on the case in which the black hemisphere 11 of the rotating ball 10 faces in the vertically upward direction, the amount of tilting of the black hemisphere 11 can be controlled by controlling the first driving voltage V1 and the time duration T1 and the second driving voltage V2 and the time duration T2.

In this case, the first driving voltage V1, the second driving voltage V2, and the time durations T1 and T2 may vary according to conditions such as the size of the rotating ball 10, the amount of charges, viscosity of the insulating oil, the interval between the upper and lower electrodes, and the like.

Meanwhile, the processing applying the first driving voltage V1 between the upper electrode 20 and the lower electrode 30 for the time duration T1 and applying the second driving voltage V2 between the upper electrode 20 and the lower electrode 30 for the time duration T2 may be repeatedly performed at least two times.

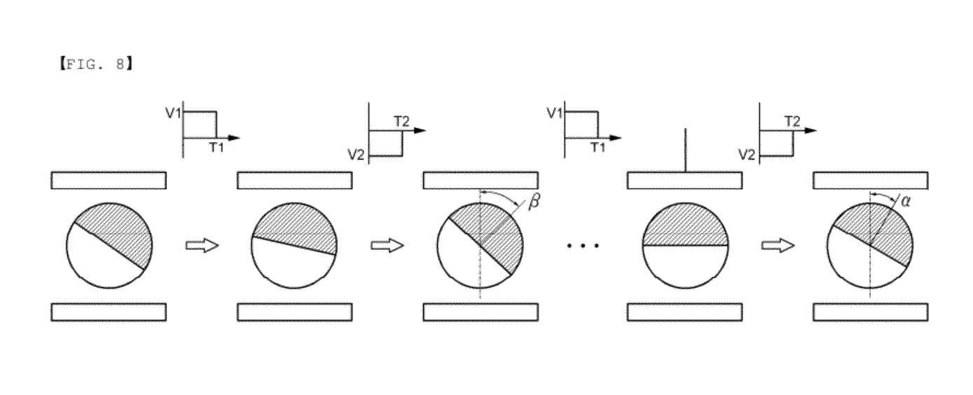

A method for driving the electronic paper display device 100 according to an exemplary embodiment of the present invention will now be described with reference to FIG. 7.

FIG. 7 is a view showing a rotated state of rotating balls 10 according to an application of a driving voltage.

The method for driving the electronic paper display device 100 according to an exemplary embodiment of the present invention may include applying the first driving voltage V1 for rotating the rotating ball 10 between the upper electrode 20 and the lower electrode 30 for the time duration T1 and applying the second driving voltage V2 for the time duration T2.

The first driving voltage V1 may serve to rotate the rotating ball 10.

Also, the first driving voltage V1 may serve to change the rotating ball 10 from a stationary state into a moving state.

The second driving voltage V2 has opposite polarity to that of the first driving voltage V1, and may serve to rotate the rotating ball 10 at a target angle.

Referring to FIG. 7, (a) shows a case in which the black hemisphere 11 of the rotating ball 10 faces in a vertically downward direction and is in a stationary state. Although FIG. 7(a) illustrates the case in which the black hemisphere 11 of the rotating ball 10 faces in the vertically downward direction, the present invention is not limited thereto.

In this state, when the first driving voltage V1 is applied for the time duration T1, it is noted that the black hemisphere 11 of the rotating ball 10 faces in the vertically upward direction as shown in FIG. 7(b). In this case, the first driving voltage V1 and the time duration T1 may vary according to conditions such as the size of the rotating ball 10, the surface friction, the amount of charges, viscosity of the insulating oil, the interval between the upper and lower electrodes, and the like. Also, unlike the case illustrated in the drawing, the present invention is not limited to the case in which the black hemisphere 11 of the rotating ball 10 faces in the vertically upward direction.

Namely, the first driving voltage V1 may be applied to the rotating ball 10 in a stationary state as shown in FIG. 7(a) for the time duration T1 to change the rotating ball 10 into a moving state as shown in FIG. 7(b).

Next, the second driving voltage V2 may be applied for the time duration T2 such that the black hemisphere 11 of the rotating ball 10 is positioned at a certain angle (i.e., α) as shown in FIG. 7(c).

In this case, the relationships among the first driving voltage V1, the second driving voltage V2, and the time durations T1 and T2 are similar to the above description regarding the electronic paper display device 100, such that a repeated description thereof will be omitted.

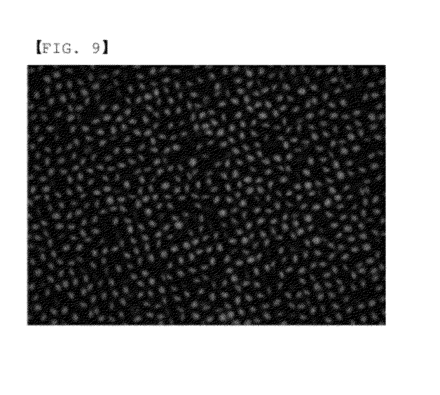

FIG. 8 is a view showing a rotated state of rotating balls according to an application of a driving voltage.

The rotating ball 10 in FIG. 8 is illustrated to have a larger diameter than that of the rotating ball 10 illustrated in FIG. 7.

Referring to FIG. 8, when the rotating ball 10 has a large diameter or has a large surface friction, it may not be able to reach the certain target angle (e.g., α in FIG. 7) by applying the first and second driving voltages V1 and V2 one time. In this case, the first and second driving voltages V1 and V2 may be repeatedly applied to allow the rotating ball 10 to eventually reach the target angle (i.e., α, or the like).

The electronic paper display device 100 may include thousands to hundreds of thousands of rotating balls 10. In this case, dispersion of rotational resistance may exist according to the characteristics of the rotating balls 10, and it may be difficult to precisely control the angle due to the dispersion of the rotational resistance.

However, even when there is difficulty in precisely controlling the angle due to the dispersion of rotational resistance, the black hemispheres 11 of the most of the rotating balls 10 can be arranged at a target angle by repeatedly applying the first and second driving voltages V1 and V2 according to an exemplary embodiment of the present invention as described above.

In this case, however, as the dispersion of the rotational resistance increases, the number of repeated applications of the first and second driving voltages V1 and V2 may be increased.

Meanwhile, the electronic paper display device 100 capable of controlling the gradation while expressing characters and images and the method for driving the electronic paper display device 100 may be implemented by appropriately combining the first and second driving voltages V1 and V2 for controlling the gradation along with the driving control signals for the respective rotating balls 10 performing the basic functions of the electronic paper display device 100, namely, expressing characters and images.

In this case, the driving control signals for the respective rotating balls 10 and the first and second driving voltages V1 and V2 for controlling the gradation may be applied to the same electrode or may be separately applied to different electrodes as provided.

FIG. 9 is a view showing a screen image output on the electronic paper display device 100 according to an exemplary embodiment of the present invention.

As shown in FIG. 9, it can be noted that, even in the electronic paper display device 100 including rotating balls 10 having various sizes, the gradation can be controlled by exposing only portions of white hemispheres 12 by applying the driving method according to an exemplary embodiment of the present invention.

According to exemplary embodiments of the present invention, the gradation can be precisely controlled in the rotating ball type electronic paper display device and a degradation of the resolution according to controlling of the gradation can be prevented. In addition, an additional electrode for controlling the gradation of rotating balls is not required.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. An electronic paper display device comprising:
rotating balls each having at least two display areas colored in different colors and including a portion charged with a positive charge and a portion charged with a negative charge;
a driving controller generating a driving voltage for rotating the rotating balls; and
an upper electrode and a lower electrode provided above and below the rotating balls, respectively, and receiving a driving voltage from the driving controller,
wherein the driving controller applies a first driving voltage for rotating the rotating balls between the upper electrode and the lower electrode for time duration T1 and applies a second driving voltage, which has a polarity opposite to that of the first driving voltage, between the upper electrode and the lower electrode for time duration T2.

2. The electronic paper display device according to claim 1, wherein the first driving voltage and the second driving voltage have the same absolute value, and time durations T1 and T2 are different.

3. The electronic paper display device according to claim 1, wherein the first driving voltage and the second driving voltage have different absolute values, and time durations T1 and T2 are equal.

4. The electronic paper display device according to claim 1, wherein the first driving voltage and the second driving voltage have different absolute values, and time durations T1 and T2 are different.

5. The electronic paper display device according to claim 1, wherein the driving controller repeatedly performs a process of applying the first driving voltage between the upper electrode and the lower electrode for the time duration T1 and applying the second driving voltage between the upper electrode and the lower electrode for the time duration T2 at least two times sequentially.

6. A method for driving an electronic paper display device in which rotating balls, each having at least two display areas colored in different colors and including a portion charged with a positive charge and a portion charged with a negative charge, are positioned between an upper electrode and a lower electrode, the method comprising:
applying a first driving voltage for rotating the rotating balls between the upper electrode and the lower electrode for time duration T1; and
applying a second driving voltage, which has a polarity opposite to that of the first driving voltage, between the upper electrode and the lower electrode for time duration T2.

7. The method according to claim 9, wherein the first driving voltage and the second driving voltage have the same absolute value, and the time durations T1 and T2 are different.

8. The method according to claim 9, wherein the first driving voltage and the second driving voltage have different absolute values, and the time durations T1 and T2 are equal.

9. The method according to claim 9, wherein the first driving voltage and the second driving voltage have different absolute values, and the time durations T1 and T2 are different.

10. The method according to claim 6, wherein the applying of the first driving voltage between the upper electrode and the lower electrode for the time duration T1 and the applying of the second driving voltage between the upper electrode and the lower electrode for the time duration T2 are repeatedly performed at least two times sequentially.

11. The method according to claim 7, wherein the applying of the first driving voltage between the upper electrode and the lower electrode for the time duration T1 and the applying of the second driving voltage between the upper electrode and the lower electrode for the time duration T2 are repeatedly performed at least two times sequentially.

12. The method according to claim 8, wherein the applying of the first driving voltage between the upper electrode and the lower electrode for the time duration T1 and the applying of the second driving voltage between the upper electrode and the lower electrode for the time duration T2 are repeatedly performed at least two times sequentially.

13. The method according to claim 9, wherein the applying of the first driving voltage between the upper electrode and the lower electrode for the time duration T1 and the applying of the second driving voltage between the upper electrode and the lower electrode for the time duration T2 are repeatedly performed at least two times sequentially.
